(19) United States
(12) Patent Application Publication
(10) Pub. No.: US 2006/0160921 A1
(43) Pub. Date: Jul. 20, 2006

(54) Non-aqueous slurries used as thickeners and defoamers and method of using slurries in aqueous systems

(76) Inventors: Pietro J. Ragone, Seven Hills, OH (US); Robert A. Martuch, Parma, OH (US); Gerald M. Sweitzer, North Ridgeville, OH (US); Joseph K. Walker, Mentor, OH (US)

Correspondence Address: Eryn Ace Fuhrer, Esq.;The Sherwin-Wlliams Company - Legal Dept., 101 Prospect Avenue, N.W., Cleveland, OH, 44115, US

(21) Appl. No.: 11/096,652

(22) Filed: Apr. 1, 2005

Related U.S. Application Data
(60) Provisional application No. 60/645,547, filed on Jan. 20, 2005.

(51) Int. Cl. C09D 5/16; C09D 101/26

(52) U.S. Cl. 523/122; 106/197.01

(57) ABSTRACT

A low VOC, HAPs free, substantially non-aqueous slurry for use as a rheology modifier in aqueous systems including but not limited to latex paints. The slurry comprises a particulate water-swelling polymer such as hydroxyethyl cellulose, mineral oil carrier liquid, a non-ionic surfactant, a particulate thickening agent, a defoamer, and optionally an amine component.

This application claims the benefit of priority from U.S. Provisional Application No. 60/645,547 filed Jan. 20, 2005, the entirety of which is hereby incorporated by reference.

### BACKGROUND

This invention is directed to a non-aqueous slurry suitable for use as a rheology modifier and defoamer in aqueous systems. More specifically, the invention is directed to a slurry containing a particulate water-swelling polymer, which when mixed with other liquids containing water, the polymer particles rapidly disperse and swell to thicken the system. The system additionally contains an anti-foaming agent, which is active in the aqueous system.

Polymers that swell in the presence of water, such as cellulose ethers, are commonly used as rheology modifiers in a variety of commercial applications, such as oil field drilling fluids, adhesives, paints, coatings, and personal care products such as ointments, creams, soaps and shampoos. Such products contain water and are generally referred to herein as “aqueous systems.” One such aqueous system is a latex paint formulation. Typical latex paint compositions include among other additives water, latex polymer, and a water-swelling polymer. Typical latex polymers include, but are not limited to, various types such as the following: acrylics, alkyds, celluloses, epoxies, esters, hydrocarbons, malaics' melamines, natural resins, oleo resins, phenolics, polyamids, polyesters, rosins, silicones, styrenes, terpenes, ureas, urethanes, vinyls, vinyl acrylics, and the like. Illustrative latex polymers include, but are not limited to, one or more homo- or copolymers containing one or more of the following monomers: (meth)acrylates, vinyl acetate, styrene, ethylene, vinyl chloride, butadiene, vinylidine chloride, vinyl versatate, vinyl propionate, t-butyl acrylate, acrylonitrile, neoprene, maleates, fumarates, and the like, including plasticized or other derivatives thereof. Various latex paints may be prepared by procedures known to those skilled in the art.

Water-swelling polymers, such as cellulose ethers, are frequently supplied in a dry state. In some applications, however, liquids are more convenient to work with than solids. For instance, finely divided particles may create dust, which can be toxic when inhaled or can create slippery surfaces or the potential for explosion, resulting in dangerous working conditions. Further, for some applications, materials in slurry or liquid form may be easier to incorporate into liquid systems than solid powders. For instance, when a water-swelling polymer, such as a cellulose ether, is added to a liquid, complications may arise due to lumps of unhydrated powder in the system. The lumps are believed to be caused by the polymer molecules not being adequately dispersed before they begin to hydrate in the aqueous system. Once the outer layer of the polymer is hydrated, the lumps cannot be re-dispersed without significant agitation, which can sometimes harm the overall viscosity of the system. In such cases, it would be beneficial to add the water-swellable polymer in a form that improves its ability to disperse in the aqueous system.

In preparing slurries of such water-swelling polymers for use in various systems, it is also important to consider whether the use of the slurry will be in compliance with various environmental regulations. In addition, it is desirable for the ingredients of the slurry to be compatible with the final system in which the slurry is employed.

### SUMMARY OF THE INVENTION

The present invention comprises a non-aqueous slurry composition adapted to act as a rheology modifier and defoamer, upon addition to an aqueous system. The slurry comprises: (a) a particulate water-swelling polymer; (b) a water-insoluble, non-oxygenated, organic liquid vehicle which is a non-solvent for said particulate polymer; (c) a surfactant compatible with said organic vehicle and present in a sufficient amount to remove said organic liquid vehicle coating from said particulate polymer upon introduction of the slurry to a system containing water; (d) a thickening agent that is present in amounts sufficient to retard stratification of the slurry; (e) a defoaming agent, which actively reduces foam in the aqueous system to which the slurry is added; and (f) an optional amine component, which may be used to accelerate the hydration of the water-swelling polymer when it is added to an aqueous system.

The slurries of the present invention are useful in various systems, including but not limited to latex paints. Indeed, slurries of the present invention include ingredients commonly found in latex paints and are therefore compatible with such paints. The slurries may also provide paint manufacturers greater efficiency in production and simpler hardware and manpower requirements as compared to using particulate water-swelling polymers. Further, use of the slurries of the present invention comply with various environmental requirements relating to volatile organic compounds (VOCs) and hazardous air pollutants (HAPs). The slurries of the present invention have a low VOC content and are HAPs free.

### DETAILED DESCRIPTION OF THE INVENTION

As used in the present specification the terms slurry, suspension, dispersion, and forms thereof are all used to refer to solid particles within a liquid carrier medium wherein the solid particles are not dissolved in the liquid carrier medium. In addition, as used in the present specification “water-swelling polymers” refers to any particulate material that thickens in the presence of water. More specific examples of such polymers are provided herein.

Particulate, water-swelling polymers for use in the present invention include those having a molecular weight of about 100,000 to about 20 million. Such polymers may also be identified by viscosity measurements. In one embodiment, water-swelling polymers having a Brookfield viscosity of about 300-6000 centipoises (cP) in a 2% by weight solution with water or a viscosity of about 1000-600 cP in a 1% by weight solution with water. In one useful embodiment, polymer preparations having a Brookfield viscosity of 300-400 cP at 2% solution with water, 4800-600 cP at 2% solution with water, and/or 2400-300 cP at 1% solution with water or combinations thereof may be used in the slurries of the present invention. Polymers having lower or greater molecular weights are also included within the scope of the invention.

The molecular weight of the polymer may indicate the rheological properties that the polymer will provide to an aqueous system when the slurry is added thereto. For example, when used in paints, low to medium molecular weight polymers will prevent stippling and splattering of the paint as it is applied to a wall. Higher molecular weight polymers, on the other hand, typically have superior thickening efficiencies. When used in paints, the higher molecular weight polymers can improve the spreadability and initial adhesion of the paint to a surface. However, use of the higher molecular weight polymers alone in paint formulations may cause undesirable foaming and splatter of the paint as it is applied to a surface. In slurries of the present invention, water-swelling polymers of relatively low, medium or high molecular weight, as well as mixtures thereof may be used, depending on the desired rheological properties of the final aqueous system to which the slurries of the present invention are added. It is also contemplated by the present invention that separate slurries each containing water-swelling polymers of different average molecular weights may be prepared and mixed together prior to adding to an aqueous system or that quantities of each slurry may be added separately to the aqueous system to achieve the desired rheology.

Water-swelling polymers that may be useful in the present invention may include cellulose ethers, including but not limited to hydroxyethyl cellulose, carboxy methyl cellulose, hydroxylpropyl methyl cellulose, hydroxylpropyl cellulose, methylcellulose, hydroxylethyl ethylcellulose, methylethyl hydroxyethyl cellulose, ethoxylated cellulose, cellulose ether, cellulose acetate, cellulose acetate propronate, cellulose tricetate, cellulose nitrate, microcrystalline cellulose and the like. Other non-cellulosic thickeners may also be used, including but not limited to hydroxypropyl guar, guar gum, polyacrylic polymer, polyvinyl pyrilidone, carboxyvinyl polymer, hydrophobically modified polyacrylic polymer, alkali-swellable polyacrylate, polyquaternium-10, xantham gum, colodial magnesium aluminum silicate, acrylic copolymer. In one embodiment, the particulate, water soluble polymer used in connection with the present invention has a particle size such that about 98% or more of the material passes through a 700 μm (20 mesh) filter and/or about 20-2000 nanometers. Various water soluble polymers useful in the slurries of the present invention are commercially available. Some examples include CELLOSIZE™ polymers available from Dow Chemical Company, BERMOCOL™ polymers available from Akzo Nobel, NATROSOL™ polymers available from Hercules, and CARBOPOL polymers available from Noveon.

A water-insoluble, organic liquid vehicle, which is a non-solvent for said particulate polymer is employed as a carrier for the water-swelling polymer. Such fluids include liquid hydrocarbons such as aliphatic hydrocarbon liquids including, but not limited to, mineral oils, kerosenes, and diesel fuels. Paraffinic, naphthenic, or aromatic mineral oils are useful as carrier vehicles for use in the present invention. Mineral oils suitable for use in the present invention are commercially available from a variety of sources, for example SUNPAR® and SUNDEX mineral oils available from Sunoco, Inc., CALSOL® mineral oil and CALPAR mineral oil both available from Calumet Oil Company.

In general the concentration of the water-insoluble organic fluid carrier vehicle, which is a non-solvent for the polymer in the non-aqueous composition, is from about 20% to 95% by total weight of the slurry formulation. The concentration of the liquid carrier may vary depending upon various conditions, including but not limited to the concentration of the particulate polymer and the concentration and/or identity of the surfactant, which will be discussed herein. In one useful embodiment, the carrier liquid is present in amounts between about 20% to about 30% by weight of the total slurry.

The concentration of such water-soluble polymers in the liquid carrier vehicle of the invention may be varied over a broad range. As little as 1% by total weight of formulation of polymer may be employed, although the dilute character of the system at this concentration requires a large storage capacity for the slurry and, for paint applications, it may require large amounts of such a dilute slurry to achieve the desired thickening. Amounts as large as about 60 weight percent of polymer can also be utilized. In general, a slurry of the present invention comprises from about 40 to 45 weight percent of polymer.

The slurry of the present invention also comprises a surfactant. The surfactant should be both unreactive and compatible with the other slurry components. The surfactant agents employed may include an emulsifier or a blend of emulsifiers compatible with the non-water-soluble carrier. The surfactant may also be soluble in the carrier vehicle or it may form a stable colloidal dispersion in the vehicle. One important characteristic of any surfactant is its hydrophobic-lipophilic balance (HLB) value. The term “HLB” is well-known to the art and is explained in detail in the publication “THE ATLAS HLB SYSTEM”, published in 1971 by Atlas Chemical Industries. In general, the higher the HLB value of a surfactant, the more water-loving the surfactant is. Within lower HLB ranges, such as from 3-5, water-in-oil type emulsions are formed with mineral oil upon addition of the non-aqueous slurry to water. Within upper HLB ranges, such as from 9-30, oil-in-water emulsions are formed upon addition of the slurry to an aqueous system.

It is important to provide the nonaqueous slurry of the invention with balanced emulsification properties, i.e., to select the surfactant agent having the HLB value for the organic vehicle employed. In one embodiment of the present invention, the surfactant agent would have a hydrophilic-lipophilic balance (HLB) with the range from 0-30. In another embodiment of the present invention, where the organic carrier vehicle is mineral oil, surfactants having HLB values of about 8-12 may be used, although surfactants having HLB values outside this range may also be used. Surfactants having an HLB value of about 8-10 are particularly useful for slurries of the present invention for use in aqueous paints.

Without limiting the scope of the invention to any particular theory, the surfactants may allow the particulate water-swelling polymer to substantially evenly disperse within an aqueous system before hydration of the polymer occurs. In addition, in one theory, the surfactants may assist in removing any coating of water insoluble carrier vehicle that has formed on the water-swelling polymer particles in a water rich environment, for instance, when the slurry is added to a latex paint base. The identity of the aqueous system to which the slurry is to be added should be considered in selecting a surfactant. Non-ionic, anionic, cationic, or amphoteric surfactants may be useful in slurries depending on the specific components in the final aqueous system. In one useful embodiment, where the aqueous system is a paint formulation, a non-ionic surfactant is used in the slurry of the present invention. Cationic surfactants may be unsuitable when the slurry is intended to be used as a rheology modifier for many known latex paints. The presence of cationic surfactants can cause agglomeration and flocculation with anionic ingredients commonly used in paints. However, depending on the exact make-up of the aqueous system to which the slurry is added, cationic surfactants may be suitable.

Suitable surfactants are well-known in the art and are commercially available. Examples of non-ionic surfactants include nonylphenol ethoxylate, e.g. TRITON® N-57, available from Dow Chemical, octylphenol ethoxylate, e.g. TRITON® X-100, TRITON® X-102, and TRITON® CF10 all available from Dow Chemical, and branched secondary alcohol ethxoylates, e.g. TERGITOL® TMN-3 available from Dow Chemical.

Surfactants or mixtures of surfactants are employed in the slurry of the present invention in amounts from about 0 to 20% by weight of total formulation, although greater or smaller amounts can be employed. In one useful embodiment, the surfactant comprises about 2% to 4% by weight of the total slurry. The particular concentration to be employed is dependent, in part, on the nature of the water-soluble polymer, its concentration, and the nature of the surfactant agent itself. Similarly, the surfactant selected is dependent upon the above factors and appropriate selections are to be made in view of the above, by those skilled in the art.

Particulate, thickening agents suitable for use in accordance with the present invention include any particulate materials which can function to thicken the slurry, and are compatible with the slurry and nonreactive with the particulate water-swelling polymer. Small amounts of the particulate thickening agent will have the ability to thicken the carrier thereby reducing stratification of the particulate water-swelling polymer during extended periods of time such as during storage and transit. The particulate thickening agents used in the present invention comprise materials which are insoluble in the carrier and comprise at least one particulate metal or metalloid oxide powder, for example, silica, alumina, alumina hydrates or clay, e.g. montmorillonites, attapulites, hectorites, and bentonites, and mixtures thereof. The particulate thickening agents may be hydrophilic of hydrophobic, e.g. surface modified with a hydrophobic agent. Thickeners for use in the present invention include, for example, finely divided silica, such as precipitated silica, fumed silica and the like. In general, the thickeners are employed in minor amounts usually between about 0.15% and about 1% by weight of the formulation. In one useful embodiment, the thickeners are employed in amounts from about 0.15 to about 0.25 by weight. Suitable particulate thickening agents are commercially available. Examples include fumed hydrophilic silica, e.g. CAB-O-SIL® M5, available from Cabot Corporation, fumed hydrophobic silica, e.g. CAB-O-SIL® TS-530 available from Cabot Corporation, organobentonite clays, e.g., BENTONE® SD-2 available from Rheox Inc., and attapulgite clay, e.g. ATTAGEL® available from Engelhard Industries. More than one thickening agent may be used in accordance with the present invention.

The thickening agent is dispersed in the liquid carrier to increase the viscosity of the fluid, and to best prevent settling of the water-swelling polymer particles. Best results are usually obtained by dispersing the thickening agent under high shear conditions and elevated temperatures as described herein. It has been discovered that the thickening agent retards the settling of the more dense water-swelling polymer from the less dense carrier. Simple, low shear mixing of the thickening agent and the liquid carrier may not be sufficient to obtain maximum fluid viscosity to prevent settling or stratification of the suspended water-swelling polymer.

A defoamer is also added to the slurry of the present invention. The defoamer may contain an anti-foam agent such as silica, silicone, a hydrophobic particulate, a fatty acid wax, or mixtures thereof. The anti-foam agent may be dispersed in a non-aqueous carrier liquid, such as those suitable for use as the carrier liquid for the slurry of the present invention. When added to an aqueous system, the defoamer reduces the amount of entrapped air thereby reducing the amount of foam in the system. Without being limited to any particular theory, when the defoamer is used in an aqueous system, the non-aqueous carrier liquid will coat a foam bubble that forms in the system. Once the coating has formed around the bubble, the anti-foam component, e.g. silica or fatty acid wax, acts as a “pin” to rupture the bubble.

The defoamer may be present in the present invention in amounts from about 0-95% by weight. In one embodiment, the defoamer comprises about 20% by weight to about 30% by weight of the total slurry. It should be noted that an excess of free oil in a latex paint may affect the properties of the paint. Excess oil may lead to increased surface defects in the applied paint and be detrimental to some physical properties of the applied paint. As shown further herein, it is can be beneficial to include the defoamer in the slurry rather than simply adding the defoamer separately to the paint base. If the defoamer is not added to the slurry, additional amounts of the liquid carrier may be needed to achieve the desired dispersion of the particulate water-swelling polymer. The addition of both a mineral oil slurry and a mineral oil based defoamer separately to the paint may cause the paint to have higher concentrations of free oil. In addition, it has been observed that including a defoamer in the slurry increases the stability of the slurry by assisting with retarding settling of the particulate water-swelling polymer out of the slurry during storage.

It has been observed that the activity of the defoamer included in slurries of the present invention has substantially similar activity in a latex paint formulation as in prior art methods when solid water-swelling polymers and mineral oil based defoamers were added separately to the paint formulation.

It has been discovered that conditions such as pH and temperature can affect the hydration time of water-swelling polymers. In particular, higher pH levels and/or elevated temperatures can reduce the hydration time of the water-swelling polymer when it is added to an aqueous system. Thus, in one embodiment of the present invention, an amine may optionally be added to the slurry. Without being limited to any particular theory, the amine may alter the pH of the aqueous system to allow hydration of the water-swelling polymer to be achieved more quickly. When a sufficient amount of amine is added to the slurry, the cellulose ether particles may begin hydration in a matter of seconds to several minutes after the addition of the slurry to an aqueous system. Although the use of an amine may cause the cellulose ether to hydrate too quickly for some applications, it may be beneficial to use an amine when the slurry is to be added to, for instance, oil drilling fluids which require almost immediate thickening.

The type and amount of amine may be selected based on the composition of the final aqueous system to which the slurry will be added. Selection of an appropriate, compatible amine may be made by those skilled in the art. Examples of amines suitable for use in the slurry of the present invention include primary amines such as 2-amino-2methyl-1-propanol, ammonium hydroxide, and monoethanolamine, secondary amines such as diethanoloamine and N,N Dimethylethanolamine, and tertiary amines such as triethanolamine. If used in connection with the present invention, an amine may be present in amounts from about 0% to about 2% by weight of the total slurry. The amine in the non-aqueous slurry has been found not to hurt the stability of the slurry.

Slurries formed in accordance with the present invention are pumpable liquids. The slurries are preferably non-aqueous, but may contain small amounts of water while still being useful for the purpose of thickening aqueous systems. As long as the water contamination does not hydrate the water-swelling polymer in the slurry to the point that the slurry is no longer a pumpable liquid, water may be present in the slurry.

Without being limited to any particular theory, it is believed that the slurries of the present invention function to thicken an aqueous system as follows: The water-insoluble vehicle may coat the water-swelling polymer particles in a hydrophobic sheath. When the composition is mixed into a system including water, the surfactant assists with dispersing the particulate polymer in the aqueous system and may carry the hydrophobic sheath or coating from the polymer particles at the proper rate to free the particles. Each particle, therefore, has an opportunity to separate from each other particle upon addition to water. Next, water penetrates the water-miscible or water-soluble coating on each particle. Then, hydration and swelling of the particles occurs. When the HEC is completely hydrated, it has achieved its optimal thickening of the aqueous system.

In order to prepare the non-aqueous water-soluble polymer containing formulations of the invention the water-insoluble vehicle is blended with the surfactant agent, the defoamer, and the thickening agent, such as fumed silica under agitation. Thereafter, the water-swelling particulate polymer is added. The entire mixture may be blended for a period of time by high shear mixing. In one embodiment, a Cowles-type high shear dispersion mixer is used to prepare the slurry of the present invention. Other high shear mixing units such as a simple turbine stirrer, roto-stator or blade-type mixers, a Scanima unit, or a Quadro mixer may also be used. The slurry may be mixed for approximately 5 minutes to approximately 60 minutes at temperatures ranging from about 100° F. to about 170° F. For example, appropriate conditions may be achieved by mixing with a Cowles-type mixer with a blade having a shaft speed of approximately 3000 rpm and a tip speed of approximately 2400 feet/min. The tip speed of the mixer, mixing time, and final temperature may all have an impact on the final properties of the slurry. In one useful embodiment, mixing is conducted to achieve a homogeneous mixture, which is stable for a period of at least several weeks. As used herein, the term “stable” means that the particulate water-swelling polymer will remain substantially dispersed in the carrier. Although there may be some syneresis or “soft settling” of the particulate water-swelling polymer, the water-swelling polymer can be easily reincorporated with slight agitation such as manual shaking or stirring. As used herein, “hard settling” is used to refer to solid particles that cannot be easily reincorporated into the slurry with manual mixing, such as shaking or stirring. In cases of “hard settling” high shear mixing may be needed to reincorporate the settled solids into the slurry. Such additional high shear mixing may be detrimental to the slurry properties and the slurry's usefulness in aqueous systems. “Syneresis” is used to refer to a stratified layer of liquid on the top of the slurry mixture that can be reincorporated into the slurry with manual mixing such as shaking or stirring. “Soft settling” is used to refer to settling of solid particulate water-swelling polymer that can be easily reincorporated with slight agitation.

The slurries of the present invention have a variety of end-use applications, such as for example, industrial applications and personal care applications. Typical industrial applications for such slurries include, for example, as viscosity adjusters, suspension aids, oil field drilling and fracturing materials, adhesion promoters for siliceous substrates, coating materials for plastic and metal substrates, and protective colloids and building materials. Typical personal care applications include, for example, pharmaceutical and cosmetic compositions, e.g. ointments, skin creams, lotions, soaps, shampoos, conditioners and the like.

One particular application for slurries in connection with the present invention is for latex paints. The amount of water-swelling polymer which may be used in a latex composition is not narrowly critical. In the broadest sense, the amount of cellulose ether is that which is effective to provide the desired thickening and rheological properties to the latex composition. Typically, the cellulose ether comprises about 0.1 to about 2.5 weight percent of the final latex paint formulation.

Details concerning the preparation of latex compositions are known to those skilled in the art. The cellulose ether slurries of the present invention can be added to latex paint at any step during the paint preparation process.

The following examples illustrate the present invention and are not intended to limit the scope of the claims. Unless stated otherwise, all percentages correspond to weight percent.

### EXAMPLE 1

This example illustrates a non-aqueous slurry in accordance with the present invention. A slurry is prepared by mixing the following ingredients:

| | Amount |
|---|---|
| Ingredient | (% by Weight) |
| Paraffinic Mineral Oil¹ | 25.00 |
| Defoamer² | 28.85 |
| Nonionic Surfactant³ | 4.00 |
| Hydroxyethyl Cellulose⁴ | 42.00 |
| Fumed Silica⁵ | 0.15 |

¹SUNPAR ® 110 available from Sunoco, Inc.
²SHERDEFOAM #1 a proprietary defoamer of the assignee of this application.
³TRITON N-57 available from Dow Chemical.
⁴CELLOSIZE QP 300 HEC available from Dow Chemical (medium-low molecular weight).
⁵CAB O SIL M5 fumed silica available from Cabot Corporation.

Using a Cowles-type high shear dispersion mixer, having a shaft speed of 3000 rpm and a tip speed of 2400 ft/min, the ingredients are mixed for 30 minutes at temperatures ranging from about 100° F. to about 130° F. The final mixture is a substantially homogeneous slurry. After storage for about 7 weeks, the slurry exhibited slight syneresis that is easily reincorporated with manual agitation (shaking).

### EXAMPLE 2

A second slurry was prepared using the following ingredients:

| | Amount |
|---|---|
| Ingredient | (% by Weight) |
| SUNPAR ® 110 | 24.85 |
| SHERDEFOAM ™ #1 Defoamer | 26.00 |
| TRITON ® N-57 | 4.00 |
| Hydroxyethyl Cellulose¹ | 45.00 |
| CAB-O-SIL ® M-5 | 0.15 |

¹CELLOSIZE ER 52M HEC available from Dow Chemical (high molecular weight).

The same procedure as explained in Example 1 is used to mix the ingredients to form a substantially homogeneous slurry that has no hard settling, only slight syneresis, after about 7 weeks of storage. The separated liquid was easily reincorporated by manual agitation (shaking).

### EXAMPLE 3

A third slurry was prepared using the following ingredients:

| | Amount |
|---|---|
| Ingredient | (% by Weight) |
| SUNPAR ® 110 | 57.85 |
| CELLOSIZE ™ QP-300 HEC | 42.00 |
| CAB-O-SIL ® M-5 | 0.15 |

The same procedure as explained in Example 1 is used to mix the ingredients to form a substantially homogeneous slurry. After storage for about 7 weeks the slurry showed hard settling of the HEC that could not be reincorporated with manual agitation (shaking).

### EXAMPLE 4

A fourth slurry was prepared using the following ingredients:

| | Amount |
|---|---|
| Ingredient | (% by Weight) |
| SUNPAR ® 110 | 53.85 |
| TRITON ® N-57 | 4.00 |
| CELLOSIZE ™ OP-300 HEC | 42.00 |
| CAB-O-SIL ® M-5 | 0.15 |

The same procedure as explained in Example 1 is used to mix the ingredients to form a substantially homogeneous slurry. After storage for about 7 weeks the slurry showed hard settling of the HEC that could not be reincorporated with manual agitation (shaking).

### EXAMPLE 5

A fifth slurry was prepared using the following ingredients:

| | Amount |
|---|---|
| Ingredient | (% by Weight) |
| SUNPAR ® 110 | 54.85 |
| CELLOSIZE ™ ER-52M HEC | 45.00 |
| CAB-O-SIL ® M-5 | 0.15 |

The same procedure as explained in Example 1 is used to mix the ingredients to form a substantially homogeneous slurry. After storage for about 7 weeks the slurry showed hard settling of the HEC that could not reincorporated with manual agitation (shaking).

### EXAMPLE 6

A sixth slurry was prepared using the following ingredients:

| | Amount |
|---|---|
| Ingredient | (% by Weight) |
| SUNPAR ® 110 | 50.85 |
| TRITON ® N-57 | 4.00 |
| CELLOSIZE ™ ER-52M HEC | 45.00 |
| CAB-O-SIL ® M-5 | 0.15 |

The same procedure as explained in Example 1 is used to mix the ingredients to form a substantially homogeneous slurry. After storage for about 7 weeks the slurry showed hard settling of the HEC that could not be reincorporated with manual agitation (shaking).

Slurries made in accordance with Examples 1-6 were stored for seven weeks. After seven weeks, the slurries were examined for settling of the HEC. The results are summarized in Table 1.

TABLE 1

| Slurry | % Settling (After 7 weeks) |
|---|---|
| Example 1 | 9.3 |
| Example 2 | 7.7 |
| Example 3 | 44.0 |
| Example 4 | 36.5 |
| Example 5 | 31.5 |
| Example 6 | 32.0 |

As described above, more significant hard settling was observed in the slurries not containing the defoamer composition. In the slurries of examples 1 and 2, only slight syneresis was observed and the separated liquid was easily reincorporated into the slurry by shaking.

### EXAMPLE 7

A representative latex coating composition could be prepared by admixing the following materials in the order shown using conventional paint preparation procedures:

| Raw Material | Parts by Weight |
|---|---|
| Acrylic emulsion¹ | 21.83 |
| Vinyl acrylic latex | 7.92 |
| Polymeric opacifying pigment² | 8.00 |
| Defoamer³ | 0.30 |
| Water | 9.97 |
| Attapulgite clay | 0.30 |
| Hydroxyethyl cellulose thickener (dry)⁴ | 0.15 |
| Tetrapotassium pyrophosphate | 0.10 |
| Zinc oxide | 1.50 |
| Surfactant⁵ | 0.82 |
| Nonionic surfactant⁶ | 0.22 |
| Defoamer⁷ | 0.15 |
| Defoamer³ | 0.20 |
| Hydrous aluminosilicate clay⁸ | 1.50 |
| Amorphous diatomaceous silica. | 0.40 |
| Water | 0.83 |
| Biocide⁹ | 0.10 |
| Trimethyl-1,3-pentanediol monoisobutyrate | 1.30 |
| Water | 2.49 |
| Water | 12.65 |
| Hydroxyethyl cellulose (dry)⁴ | 0.42 |
| Hydroxyethyl cellulose (dry)¹⁰ | 0.31 |
| Water | 6.65 |
| Titanium dioxide slurry¹¹ | 22.00 |

¹Rhoplex AC 264 from Rhom and Haas
²Ropaque OP-96 from Rohm and Haas
³Sher-Defoam #1 a proprietary defoamer of the assignee of this application
⁴CELLOSIZE QP-300 from Dow Chemical
⁵Tamol 731A from Rohm and Haas
⁶Triton CF-10 nonionic surfactant from Dow
⁷Defoamer 697 from Rhodia
⁸ASP400P from Engelhard.
⁹SKANE M8 from Rhom and Haas.
¹⁰CELLOSIZE ER52M from Dow Chemical.
¹¹R-746 from DuPont

### EXAMPLE 8

A second latex coating composition could be prepared by admixing the following materials in the order shown using conventional known paint preparation procedures:

| Raw Material | Parts by Weight |
|---|---|
| Acrylic emulsion¹ | 21.65 |
| Vinyl acrylic latex | 7.85 |
| Polymeric opacifying pigment² | 7.93 |
| Defoamer³ | 0.15 |
| Water | 9.89 |
| Attapulgite clay | 0.30 |
| Slurry of example 1 | 0.35 |
| Tetrapotassium pyrophosphate | 0.10 |
| Zinc oxide | 1.49 |
| Surfactant⁴ | 0.81 |
| Nonionic surfactant⁵ | 0.22 |
| Defoamer⁶ | 0.15 |
| Hydrous aluminosilicate clay⁷ | 1.49 |
| Amorphous diatomaceous silica | 0.40 |
| Water | 0.82 |
| Biocide⁸ | 0.10 |
| Trimethyl-1,3-pentanediol monoisobutyrate | 1.29 |
| Water | 2.47 |
| Water | 12.55 |
| Slurry of example 1 | 0.99 |
| Slurry of example 2 | 0.68 |
| Water | 6.59 |
| Titanium dioxide slurry⁹ | 21.82 |

¹Rhoplex AC 264 from Rhom and Haas
²Ropaque OP-96 from Rohm and Haas
³Sher-Defoam #1 a proprietary defoamer of the assignee of this application
⁴Tamol 731A from Rohm and Haas
⁵Triton CF-10 nonionic surfactant from Dow
⁶Defoamer 697 from Rhodia
⁷ASP400P from Engelhard
⁸SKANE M8 from Rhom and Haas
⁹R-746 from DuPont

### EXAMPLE 9

A third latex coating composition could be prepared by admixing the following materials in the order shown using conventional known paint preparation procedures

| Raw Material | Parts by Weight |
|---|---|
| Acrylic emulsion¹ | 21.65 |
| Vinyl acrylic latex | 7.85 |
| Polymeric opacifying pigment² | 7.93 |
| Defoamer³ | 0.15 |
| Water | 9.89 |
| Attapulgite clay | 0.30 |
| Slurry of example 3 | 0.35 |
| Tetrapotassium pyrophosphate | 0.10 |
| Zinc oxide | 1.49 |
| Surfactant⁴ | 0.81 |
| Nonionic surfactant⁵ | 0.22 |
| Defoamer⁶ | 0.15 |
| Hydrous aluminosilicate clay⁷ | 1.49 |
| Amorphous diatomaceous silica | 0.40 |
| Water | 0.82 |
| Biocide⁸ | 0.10 |
| Trimethyl-1,3-pentanediol monoisobutyrate | 1.29 |
| Water | 2.47 |
| Water | 12.55 |
| Slurry of example 3 | 0.99 |
| Slurry of example 5 | 0.68 |
| Water | 5.95 |
| Defoamer⁶ | 0.55 |
| Titanium dioxide slurry⁹ | 21.82 |

¹Rhoplex AC 264 from Rhom and Haas
²Ropaque OP-96 from Rohm and Haas
³Sher-Defoam #1 a proprietary defoamer of the assignee of this application.
⁴Tamol 731A from Rohm and Haas
⁵Triton CF-10 nonionic surfactant from Dow
⁶Defoamer 697 from Rhodia
⁷ASP400P from Engelhard
⁸SKANE M8 from Rhom and Haas
⁹R-746 from DuPont

### EXAMPLE 10

A second latex coating composition could be prepared by admixing the following materials in the order shown using conventional known paint preparation procedures:

| Raw Material | Parts by Weight |
|---|---|
| Acrylic emulsion¹ | 21.65 |
| Vinyl acrylic latex | 7.85 |
| Polymeric opacifying pigment² | 7.93 |
| Defoamer³ | 0.15 |
| Water | 9.89 |
| Attapulgite clay | 0.30 |
| Slurry of example 4 | 0.35 |
| Tetrapotassium pyrophosphate | 0.10 |
| Zinc oxide | 1.49 |
| Surfactant⁴ | 0.81 |
| Nonionic surfactant⁵ | 0.22 |
| Defoamer⁶ | 0.15 |
| Hydrous aluminosilicate clay⁷ | 1.49 |
| Amorphous diatomaceous silica | 0.40 |
| Water | 0.82 |
| Biocide⁸ | 0.10 |
| Trimethyl-1,3-pentanediol monoisobutyrate | 1.29 |
| Water | 2.47 |
| Water | 12.55 |
| Slurry of example 4 | 0.99 |
| Slurry of example 6 | 0.68 |
| Water | 5.95 |
| Defoamer⁶ | 0.55 |
| Titanium dioxide slurry⁹ | 21.82 |

¹Rhoplex AC 264 from Rhom and Haas
²Ropaque OP-96 from Rohm and Haas
³Sher-Defoam #1 a proprietary defoamer of the assignee of this application.
⁴Tamol 731A from Rohm and Haas
⁵Triton CF-10 nonionic surfactant from Dow
⁶Defoamer 697 from Rhodia
⁷ASP400P from Engelhard.
⁸SKANE M8 from Rhom and Haas
⁹R-746 from DuPont

Rheology profiles were prepared of paints made substantially in accordance with examples 7-10 above using a TA Instruments AR500 Rheometer using a 4 cm parallel plate geometry at 25° C. The thickening responses of all four paints were substantially identical. In addition, the viscosity of paints prepared using slurries of the present invention and dry HEC compositions were measured. The rheology profiles of those paints were also substantially identical.

In addition, for paints made in accordance with examples 7 and 8, the amount of foam observed in the container was substantially identical indicating that the defoamer added to the paint in connection with the slurry has the same foam reducing activity as a separately added defoamer.

The tensile strengths of dried paint samples were then tested. 25 mil thickness wet draw-downs were dried and conditioned under ambient conditions (70° F.-75° F./40-70% relative humidity) for about 2 weeks. 2.5 inch tensile dogbones, approximately 0.1 mm thick, were strained at a rate of 1 inch per minute (per ASTM #D638). The test was repeated on different samples 4-5 times. The results were averaged and are summarized in Table 2.

TABLE 2

| | | | Tensile | % Change |
|---|---|---|---|---|
| Paint | Viscosity | ICI Viscosity | Strength | Tensile |
| Example | (KU) | (Poise) | (psi) | Strength |
| 7 | 98 | 0.524 | 707 | 0.0 |
| 8 | 99 | 0.550 | 627 | 11.3 |
| 9 | 99 | 0.521 | 535 | 24.3 |
| 10 | 97 | 0.571 | 519 | 26.6 |

### EXAMPLE 11

A fifth slurry may be prepared with an added amine component:

| | Amount |
|---|---|
| Ingredient | (% by Weight) |
| SUNPAR ® 110 | 21.28 |
| SHERDEFOAM #1 | 35.46 |
| HEC¹ | 40.00 |
| TRITON N-57 | 2.00 |
| 2-amino-2-methyl-1-propanol | 1.25 |

¹CELLOSIZE ER52M or CELLOSIZE QP-300.

The effect of the addition of an amine component to the slurries of the present invention was measured as follows: varying amounts of 2-amino-2-methyl-1-propanol (AMP-95 from Angus a division of Dow Chemical) were added to slurries in accordance with the present invention. The amount of mineral oil in the total slurry was decreased by the equivalent amount of amine. The slurries were mixed into a latex paint formulations and the amount of time for onset of the activation of the hydration of the particulate water-swelling polymer was measured. The results are summarized in Table 3.

TABLE 3

| Weight % Amine in Slurry | Activation Time (Seconds) |
|---|---|
| 0.00 | 150 |
| 0.25 | 150 |
| 0.50 | 120 |
| 0.75 | 120 |
| 1.00 | 120 |
| 1.25 | 90 |
| 1.50 | 90 |

The effect on hydration time of various amines was also measured. 1% by weight of various primary, secondary and tertiary amines were added to slurries of the present invention. The total time for complete hydration of the HEC was measured. The results are summarized in Table 4.

TABLE 4

| Amine Type | Hydration Time (min) |
|---|---|
| 2-amino-2-methyl-1-propanol | 15 |
| Ammonia 28% | 20 |
| Triethanolamine | 45 |
| Monoethanolamine | 35 |
| Diaethanolamine | 36 |
| Dimethylethanolamine | 33 |

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. A slurry, adapted to modify the rheology of a latex paint composition, comprising:
(a) from about 40% to about 45%, based on the total weight of the slurry, of a particulate water-swelling polymer having a molecular weight of about 100,000 to about 20 million;
(b) from about 20% to about 30%, based on the total weight of the slurry, of a water-insoluble organic carrier vehicle which is a non-solvent for the water-swelling polymer;
(c) from about 20% to about 30% of a mineral oil based defoamer, wherein the defoamer is adapted to actively reduce foam in the latex paint composition;
(d) from about 2% to about 4%, based on the total weight of the slurry, of a non-ionic surfactant having an HLB value of about 8-12; and
(e) from about 0.15% to 0.25% based on the total weight of the slurry of a particulate thickening agent.

2. The slurry of claim 1 further comprising about 0.1% to about 2% based on the total weight of the slurry of an amine.

3. The slurry of claim 2 wherein the amine is selected from the group consisting of 2-amino-2-methyl-1-propanol, ammonium hydroxide, monoethanolamine, diethanolamine, N, N dimethylethanolamine, triethanolamine.

4. The slurry of claim 1 wherein the defoamer is selected from silicone, a fatty acid wax, or a hydrophobic particulate or mixtures thereof.

5. The slurry of claim 1 wherein the defoamer comprises mineral oil treated with hydrophobic silica.

6. The slurry of claim 1 wherein the particulate water-swelling polymer comprises hydroxyethyl cellulose.

7. The slurry of claim 1 wherein the particulate water-swelling polymer is selected from the group consisting of hydroxyethyl cellulose, carboxy methyl cellulose, hydroxylpropyl methyl cellulose, hydroxylpropyl cellulose, methylcellulose, hydroxylethyl ethylcellulose, methylethyl hydroxyethyl cellulose, ethoxylated cellulose, cellulose ether, cellulose acetate, cellulose acetate propronate, cellulose tricetate, cellulose nitrate, microcrystalline cellulose, hydroxypropyl guar, guar gum, polyacrylic polymer, carboxyvinyl polymer, hydrophobically modified polyacrylic polymer, alkali-swellable polyacrylate, polyquaternium-10, xantham gum, colodial magnesium aluminum silicate, and acrylic copolymer.

8. The slurry of claim 1 wherein the water-insoluble carrier vehicle comprises mineral oil.

9. A slurry composition comprising:
(a) from about 40% to about 45% based on the total weight of the slurry of hydroxyethyl cellulose;
(b) from about 20% to about 30% based on the total weight of the slurry of mineral oil;
(c) from about 20% to about 30% based on the total weight of the slurry of a mineral oil based defoamer;
(d) from about 0.15% to about 0.25% based on the total weight of the slurry of fumed silica; and
(e) from about 2% to about 4% based on the total weight of the slurry of a non-ionic surfactant having an HLB value of about 8 to about 10.

10. The slurry of claim 9 further comprising from about 0.1 to about 2% based on the total weight of the slurry of an amine composition.

11. A slurry composition for use in thickening a paint formulation comprising:
(a) polymer particles capable of swelling in the presence of water, wherein said polymer particles are suspended in a hydrocarbon carrier liquid, wherein the hydrocarbon carrier liquid is present in sufficient amounts to coat the polymer particles;
(b) a defoamer composition, said defoamer composition adapted to actively reduce foam when the slurry is in the paint formulation;
(c) fumed silica;
(d) a non-ionic surfactant.

12. The slurry of claim 11, wherein the polymer particles capable of swelling in the presence of water are selected from the group consisting of hydroxyethyl cellulose, carboxy methyl cellulose, hydroxylpropyl methyl cellulose, hydroxylpropyl cellulose, methylcellulose, hydroxylethyl ethylcellulose, methylethyl hydroxyethyl cellulose, ethoxylated cellulose, cellulose ether, cellulose acetate, cellulose acetate propronate, cellulose tricetate, cellulose nitrate, microcrystalline cellulose, hydroxypropyl guar, guar gum, polyacrylic polymer, carboxyvinyl polymer, hydrophobically modified polyacrylic polymer, alkali-swellable polyacrylate, polyquaternium-10, xantham gum, colodial magnesium aluminum silicate, and acrylic copolymer.

13. The slurry of claim 11, wherein the polymer particles are hydroxyethyl cellulose.

14. The slurry of claim 11, wherein the defoamer comprises mineral oil treated with hydrophobic silica.

15. A slurry composition for use in thickening an aqueous system comprising:
(a) a mixture of water-swelling polymer particles having various average molecular weights dispersed in mineral oil;
(b) a surfactant;
(c) a thickening agent;
(d) a defoamer, wherein the defoamer actively reduces foam in the aqueous system.

16. The slurry as recited in claim 15, wherein the mixture comprises a high molecular weight water-swelling polymer having a viscosity of about 2400 cP to about 300 cP in a 2% by weight solution with water.

17. The slurry as recited in claim 15, wherein the mixture comprises a low molecular weight water-swelling polymer having a viscosity of about 300 cP to about 400 cP in a 2% by weight solution with water.

18. The slurry as recited in claim 15 wherein the surfactant is a non-ionic surfactant.

19. The slurry as recited in claim 15 wherein the surfactant has an HLB value of about 8 to about 12.

20. The slurry as recited in claim 15 wherein the surfactant has an HLB value of about 8 to about 10.

21. The slurry as recited in claim 15 wherein the thickening agent comprises fumed silica.

22. The slurry as recited in claim 15 wherein the defoamer comprises hydrophobic silica dispersed in mineral oil.

23. The slurry as recited in claim 15 further comprising an amine.

24. The slurry as recited in claim 23 wherein the amine is selected from the group consisting of 2-amino-2-methyl-1-propanol, ammonium hydroxide, monoethanolamine, diethanolamine, N,N dimethylethanolamine, triethanolamine.

25. A composition adapted to modify the rheological properties of an aqueous system, upon dilution with water, the composition comprising:
(a) polymer particles which swell in the presence of water;
(b) a water-insoluble, non-oxygenated, liquid carrier which is a non-solvent for said polymer particles;
(c) a non-ionic surfactant present in sufficient amounts to allow said polymer particles to substantially disperse in the aqueous system prior to swelling;
(d) a thickening agent present in amounts sufficient to retard settling of the polymer particles in the composition; and
(e) a defoamer, wherein said defoamer is adapted to be active upon dilution of the composition with water,
wherein the polymer particles remain suspended in the liquid carrier during storage.

26. The composition of claim 25 wherein said polymer particles are selected from the group consisting of hydroxyethyl cellulose, carboxy methyl cellulose, hydroxylpropyl methyl cellulose, hydroxylpropyl cellulose, methylcellulose, hydroxylethyl ethylcellulose, methylethyl hydroxyethyl cellulose, ethoxylated cellulose, cellulose ether, cellulose acetate, cellulose acetate propronate, cellulose tricetate, cellulose nitrate, microcrystalline cellulose, hydroxypropyl guar, guar gum, polyacrylic polymer, carboxyvinyl polymer, hydrophobically modified polyacrylic polymer, alkali-swellable polyacrylate, polyquaternium-10, xantham gum, colodial magnesium aluminum silicate, and acrylic copolymer.

27. The composition of claim 25 wherein said polymer particles are hydroxyethyl cellulose.

28. The composition of claim 25 wherein the liquid carrier comprises mineral oil.

29. The composition of claim 25 wherein the defoamer comprises a mineral oil based defoamer.

30. The composition of claim 25 wherein the surfactant has an HLB value of about 8-12.

31. A composition for thickening a paint formulation, said composition comprising:
a first particulate hydroxyethyl cellulose having a first average molecular weight;
a second particulate hydroxyethyl cellulose having a second average molecular weight;
a hydrocarbon carrier liquid;
a defoamer composition, wherein said defoamer composition actively reduces foam in the paint formulation;
a surfactant; and
a thickening agent in sufficient amounts to retard stratification of the first and second particulate hydroxyethyl cellulose in the slurry.

32. A method for thickening a paint formulation, said method comprising the steps of:
preparing a first slurry comprising:
about 42% by weight of hydroxyethyl cellulose;
about 25% by weight of a paraffinic mineral oil;
about 28% to about 29% by weight of a mineral oil based defoamer;
about 4% by weight of a non-ionic surfactant; and
less than about 1% by weight of fumed silica;
preparing a second slurry comprising:
about 45% by weight of a hydroxyethyl cellulose having a higher molecular weight than the hydroxyethyl cellulose in the first slurry;
about 24% to about 25% by weight of paraffinic mineral oil;
about 26% by weight of a mineral oil based defoamer;
about 4% by weight of a non-ionic surfactant; and
less than about 1% by weight of fumed silica;
adding said first slurry and said second slurry to a paint base.

33. The method as recited in claim 32 wherein the first slurry comprises about 66% of the composition and the second slurry comprises about 34% of the total slurry weight.

34. The method as recited in claim 32 wherein the first slurry comprises 66.32% of the composition and the second slurry comprises about 33.68% of the total slurry weight.

35. The method as recited in claim 32 wherein the non-ionic surfactant has an HLB value of about 8 to about 12.

36. A method of preparing a slurry for use in thickening a paint formulation, the method comprising the steps of:
combining particulate hydroxyethyl cellulose, mineral oil, a non-ionic surfactant, fumed silica, and a mineral oil based defoamer;
mixing said hydroxyethyl cellulose, mineral oil, non-ionic surfactant, fumed silica, and defoamer under high shear conditions until a homogeneous slurry is achieved.

37. A method for thickening a paint formulation, said method comprising:
preparing at least one slurry comprising a particulate water-swelling polymer, mineral oil, a surfactant, fumed silica, and a defoamer, wherein said defoamer is adapted to actively reduce foam when the slurry is added to the paint formulation and wherein said slurry is capable of being stored without hard settling for at least seven weeks;
preparing a paint base;
adding said slurry to said paint base;
mixing said slurry and said paint base to achieve a homogeneous dispersion.

38. The method as recited in claim 37, wherein the particulate water-swelling polymer comprises hydroxyethyl cellulose.

39. The method as recited in claim 37, wherein the at least one slurry comprises two slurries.

40. The method as recited in claim 39, wherein the two slurries comprise a first slurry and a second slurry and wherein the second slurry comprises a water-swelling polymer that has a higher average molecular weight than a water-swelling polymer in the first slurry.

41. The method as recited in claim 37, wherein the surfactant is a non-ionic surfactant.

42. The method as recited in claim 41, wherein the surfactant has an HLB value of about 8 to about 12.

43. The method as recited in claim 37, wherein the defoamer comprises hydrophobic silica dispersed in mineral oil.
